(19) United States
(12) Patent Application Publication
(10) Pub. No.: US 2005/0087054 A1
(43) Pub. Date: Apr. 28, 2005

(54) Device for cutting flat, two-dimensional materials made mostly of minerals, particularly glass such as composite safety glass

(76) Inventor: Frank Reichel, Berlin (DE)

Correspondence Address: BIRCH STEWART KOLASCH & BIRCH, PO BOX 747, FALLS CHURCH, VA, 22040-0747, US

(21) Appl. No.: 10/501,481

(22) PCT Filed: Jan. 14, 2003
(86) PCT No.: PCT/DE03/00084

(30) Foreign Application Priority Data
Jan. 15, 2002 (DE) 102 01 253.9

(51) Int. Cl. B26D 5/08

(52) U.S. Cl. 83/614

(57) ABSTRACT

An apparatus for cutting sheet materials consisting mainly of mineral substances, particularly glass such as laminated safety glass. The apparatus is flexible to handle and to use. In a broader sense, these materials include materials such as ceramic tiles and/or natural stone plates, of which the characteristics do not adversely influence the cutting process and of which the cross-sectional structure comprises several layers including different materials, such as laminated safety glass.

### FIELD OF THE ART

The present application relates to apparatus for cutting sheet materials consisting mainly of mineral substances, particularly glass such as laminated safety glass, which apparatus is flexible to handle and to use. In a broader sense, these materials include materials such as ceramic tiles and/or natural stone plates, of which the characteristics do not adversely influence the cutting process and of which the cross-sectional structure comprises several layers-including different materials, such as laminated safety glass.

### PRIOR ART

As regards procedure, it has been known by DE 43 30 473 A1, DE 44 44 184 C2 and DE 42 28 907 A1 to start out by scoring glass sheets such as laminated or multilayer glass on both sides, to then break them apart and to finally sever the plastic film disposed between the glass layers by means of a plasma beam, a knife or other means, with the two sides of the sheet structure being scored simultaneously.

It has been known likewise by U.S. Pat. No. 1,495,523 A and U.S. Pat. No. 2,265,955 A to use apparatus for cutting glass sheets comprising a guide arm having attached thereto two parallel longer arms each supporting a cutting tool, this apparatus allowing laminated glass sheets to be cut.

Finally, U.S. Pat. No. 4,222,300 proposes apparatus including a cutting wheel placed opposite a roll.

If this state of the art is viewed jointly and applied to the cutting of the materials initially stated, such as sheets of glass and particularly of laminated safety glass, the following drawbacks will be found—in the order of the cited prior art—which apparatus so conceived would exhibit:
The cutting of narrow stripes is not possible and the sheet materials must be re-positioned in the cutter for each new cut to be started;
The cutting device is predisposed for stationary operation, i.e. the severing of the plastic film of laminated safety glass would present problems;
The device is required to have a stationary table and exhibits the aforesaid shortcomings;
If constructed as a manual device having a resilient frame, the cutter allows one-sided cutting only; even if designed for two-sided cutting, the device would not ensure positive guidance of the tools on the material.
Without fixed guide means, it is not be possible to use the cutting device in the field.

The invention starts out from the problem that the relatively large materials supplied by industry for further processing—such as laminated glass sheets—must be cut to the desired dimensions on both sides simultaneously. Thereafter the sheet, which is large and heavy, is removed from the table or—in the field—must be held by two persons and turned over. Finally, the sheet is drawn over an edge and broken apart by being moved up and down, whereafter the plastic film between the layers is severed.

This procedure gives rise to the aforesaid drawbacks. It is not possible to cut the said materials in a rational and high-quality manner.

Neither can the problem be overcome by the teaching of U.S. Pat. No. 4,739,555 A. This reference teaches apparatus for cutting glass sheets which comprises a frame having arms in a bifurcated arrangement mounting a cutting tool on each free end thereof and an adjustable transverse member for adjusting the spacing between the cutting tools. The required bias is produced by biasing elements provided at each one of the two cutting tools, which presents a disadvantage, and the single guide roll arrangement the prior teaching proposes does not allow precise guidance to be obtained.

### THE INVENTION

The object underlying the invention is to provide apparatus for cutting planar materials of the kind described hereinabove, especially glass such as laminated safety glass, which apparatus
is suited for stationary use in the shop and in any orientation in the field, i.e. also if the sheet material is vertically oriented, and is easily handled by a single person;
facilitates and rationalizes the severing of portions from materials such as glass sheets while maintaining a high quality—such as dimensional accuracy and avoidance of breakage—and at the same time ensures safety from accidents; and
is designed to have a frame with arms, guide elements and cutting tools disposed on both sides to act simultaneously, with the novel design elements conceived to eliminate the aforesaid drawbacks of the prior art devices.

In accordance with the invention, this object is achieved with the features in claims 1 to 15.

The invention is described below by way of an embodiment example.

### BRIEF DESCRIPTION OF THE DRAWINGS

FIG. 1 shows a simplified view in perspective of apparatus 1 in an operational orientation;

FIG. 2 shows frame 2 of apparatus 1 with cutting a head 3 and transverse member 4 in plan;

FIG. 3 shows a lateral longitudinal section of frame 2 of FIG. 2;

FIG. 4 shows a front view of transverse member 4 with guide head 4.1;

FIG. 5 shows a top plan view of transverse member 4 of FIG. 4;

FIG. 6 shows transverse member 4 of FIG. 4 in elevation.

### BEST MODE OF IMPLEMENTING THE INVENTION

A material 5 can generally consist of predominantly mineral substances and constitute a planar or sheet element. In particular, material 5 can be glass and preferably a sheet of laminated safety glass, which is most suited to demonstrate the embodiment example.

Sheets of laminated safety glass 5 are cut to size not only in a workshop, but frequently in the field as well.

The advantages accruing from the use of the inventive apparatus 1 will be evident from a consideration of the dimensions to be set relative to a reference edge of said material 5, the guiding of apparatus 1 having the generic features along the reference edge of material 5 (such as laminated safety glass) while placing the cut, and the universal handling of the apparatus regardles of the orientation and/or geometric position of the material 5 (such as a sheet of laminated safety glass), including vertical positions or orientations that make handling it difficult, as on construction sites.

Thus the design of a frame 2, as well as its universal left- or right-handed application, gain particular significance and importance in connection with its main objective, namely, the cutting of the aforesaid material 5, which may be in the nature of tiles.

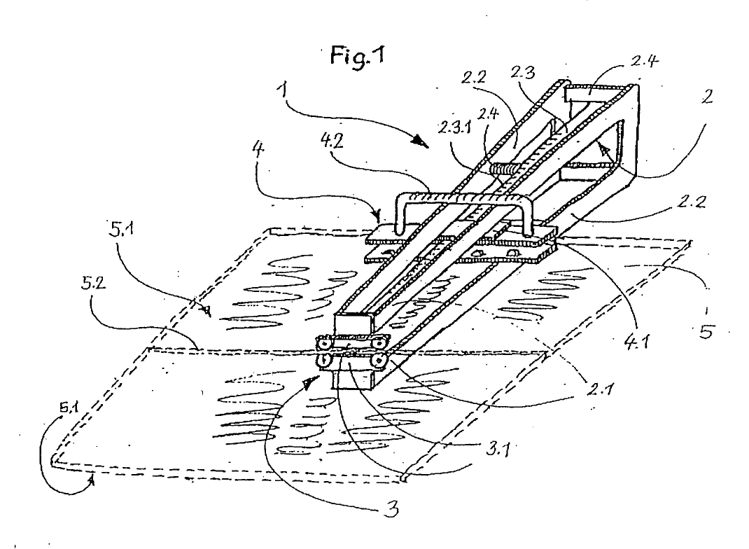

In accordance with the overall representation in FIG. 1, the inventive apparatus 1 consists of a frame 2 having arms 2.1 in a fork-like or bifurcated arrangement. The distance between the free ends of arms 2.1 is adapted to be varied under bias. These free ends mount cutting tools 3.1 forming a cutting head 3 and acting under the bias exerted by arms 2.1 on the two material planes 5.1 of the material 5 to be cut.

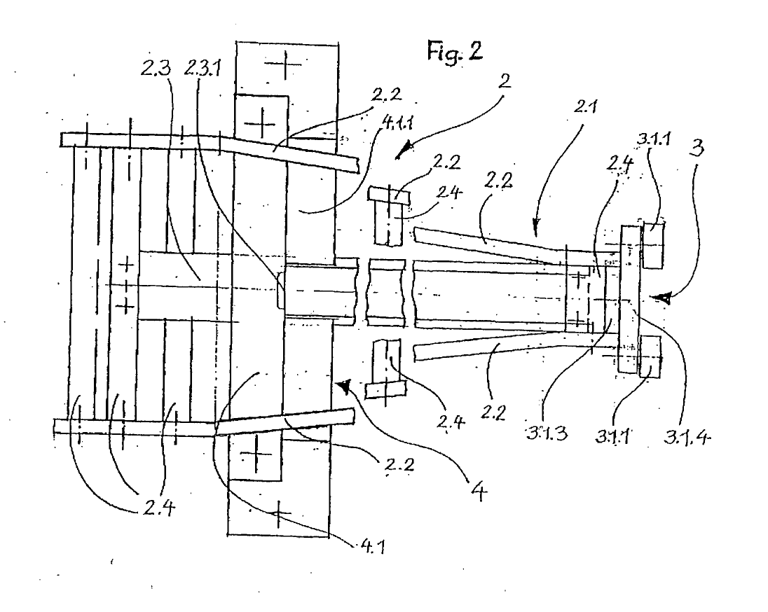

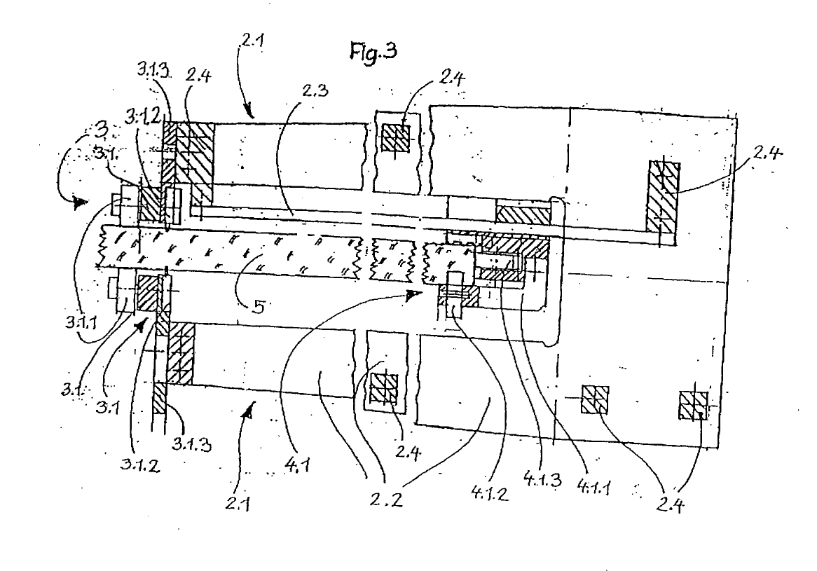

As evident from FIGS. 2 and 3, cutting tools 3.1 have associated therewith first guide rolls 3.1.1, of which the positions relative to material planes 5.1 are adjustable.

One arm 2.1 (in this case the top one in FIG. 1) has integrally attached thereto a guide rail 2.3 (see FIG. 2) having graduations or a scale 2.3.1 thereon (FIG. 5). Guide rail 2.3 has thereon a transverse member 4 which is mounted for adjustment in the longitudinal direction of arm 2.1 and adapted to be secured in place in order to allow the cutting distance from the desired reference edge of material 5 to be adjusted in a dimensionally accurate manner.

As shown in FIG. 3, transverse member 4 has a guide head 4.1 which straddles the reference edge of the material 5 to be cut, is guided thereby and is adapted to be biased against material 5 to adjusted to the thickness thereof. A handle 4.2 (shown in this case to be secured to guide had 4.1) serves to manipulate the device and to enable the user to directly control its movements.

In the light of the complexity of the underlying problem to be solved, as detailed above, the novel combination of these main inventive features and their functional interaction exhibit the advantages over the pri- or art set forth above, especially if the material to be processed comprises the aforesaid glass sheets.

In order to realize a lightweight construction of apparatus 1, forked arms 2.1 consist of a pair of U-shaped planar elements 2.2 held in a mutually spaced relationship by connecting elements 2.4.

On the one hand, this results in an extremely light-weight frame 2 which is stable but exhibits at the free ends of its arms 2.1 the desirable resilient properties. This presents a major advantage for causing cutting tools 3.1 to exert pressure on material planes 5.1 and for adjusting—or for providing for the adjustability of—cutting tools 3.1 to the thickness of material 5.

On the other hand, this lightweight frame 2 optimizes the universal handling characteristics of the inventive apparatus.

As shown in FIG. 3, cutting tools 3.1 mounted on the free ends of arms 2.1 of frame 2 (FIGS. 1 and 2) may comprise cutting wheels 3.1.2.

On the one hand, the first guide rolls 3.1.1 shown in greater detail in FIGS. 2 and 3 ensure an optimum position of cutting tools 3.1 regarding a guiding pressure acting towards cutting planes 5.1 (FIG. 1); on the other hand, they minimize the resistance required for cutting material 5. This effect is obtained mainly by the resilient bias exerted by the free ends of arms 2.1 of frame 2.

The overall functionality of the inventive apparatus is assisted by cutting tools 3.1 (FIG. 3) forming identically constructed components and enhancing the aforesaid effect by having
A supporting body 3.1.3 each, with at least one of said bodies mounted on the free end of one of arms 2.1 to obtain a variabille vertical position relative to cutting plane 5.1;
Travellers 3.1.4 secured to supporting body 3.1.3 to carry first guide rolls 3.1.1 and cutting tools 3.1 positioned between said guide rolls 3.1.1, with the mutual distance between supporting bodies 3.1.3 being variable at least by virtue of the bias of arms 2.1;
A distance between first guide rolls 3.1.1 and cutting tool 3.1, seen in a direction vertical to material plane 5.1, which ensures a guiding pressure and minimizes the resistance required for cutting material 5.

In functional cooperation with the material 5 to be cut, guide head 4.1 has—see FIGS. 3, 5 and 6—guide elements 4.1.2 corresponding to both material planes 5.1 (FIG. 1) and to the reference edge of material 5 (FIG. 3), which guide elements are adjustable for movement towards each other and have second and third guide rolls 4.1.2 and 4.1.3, respectively. Accordingly, guide head 4.1 performs complex functions such as the guiding of apparatus 1, dimensional accuracy of the cut by virtue of guide rail 2.3 with graduations 2.3.1 thereon (FIG. 5) and the handling of apparatus 1 by means of a handle 4.2 secured to one of guide elements 4.1.1 (FIG. 3) to reach around one arm 2.1 of frame 2.

Conveniently, first guide rolls 3.1.1, second guide rolls 4.1.2 and third guide rolls 4.1.3 have wear-resistant and/or low-friction coatings on at least the rolling surfaces thereof.

In order to allow varying sizes of inventive apparatus 1 to be manufactured in a technologically convenient manner, at least one of the aforesaid modules or component parts is designed to be replaceable. Also to this end, frame 2 should be variable in size by using sections thereof which vary in size.

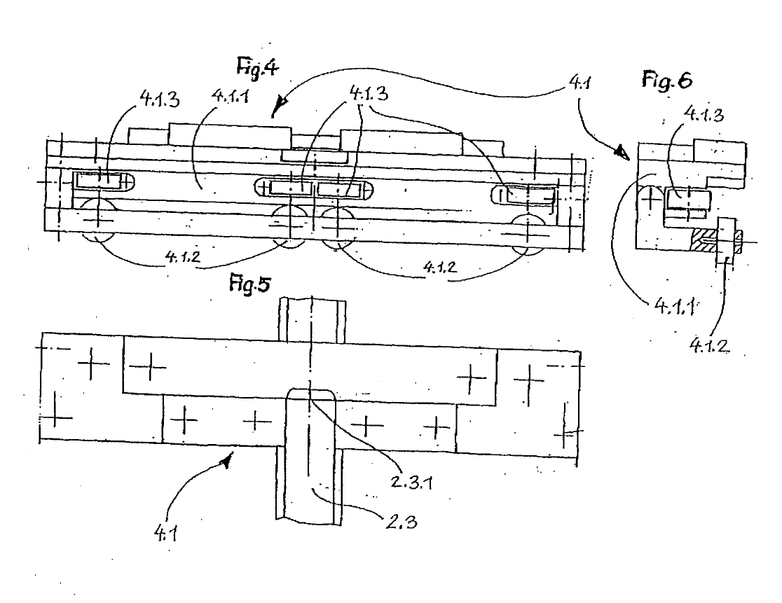

Conveniently, and as shown schematically in FIG. 6, the distance between guide elements 4.1.1 of guide head 4.1 should be made to be articulatedly adjustable against the bias of at least one resilient or spring element (not shown).

Finally, apparatus 1 is expandable in the following respect:
At least one guide element 4.1.1 having handles is movably mounted on guide rail 2.3 as a component part of transverse element 2.3 (FIGS. 3, 4 and 5);
Transverse element 4 is adapted to be secured in place in one reference position only and apparatus 1 can perform arcuate cuts, with block-like inserts allowing any kind of cut 5.2 to be realized.

Most conveniently, frame 2 should have a cross-sectional shape tapering from its closed rear end to its front end forming the free ends of arms 2.1 which receive cutting head 3.

Further, the rear end of frame 2 is configured to form a second handle (not shown), as indicated in FIG. 1.

### Industrial Applicability

The present invention provides apparatus 1 for trade and industrial practice which has turned out to be a valuable tool in in-house testing. The device substantially eliminates the drawbacks initially set forth of prior art designs.

When apparatus 1 is used for cutting laminated safety glass 5, the usual severing of the plastics film provided between the glass layers can be performed as in the past.

In accordance with the basic principles of the inventive design, it is possible to provide ergonomically adapted variants—for left- and right-handed individuals, for example—and to implement these in a cost-effective manner.

On the whole, and on the basis of the underlying problems and objectives, the use of apparatus 1 allows all operations required in practical work to be performed in a comprehensive and efficient manner without having to tolerate the drawbacks of prior art devices.

1. Apparatus for cutting sheet materials consisting of predominantly mineral substances, such as laminated safety glass, to dimensions adjustable relative to a reference edge of the material, comprising a frame mounting oppositely disposed cutting tools acting simultaneously on both major planes of the material, as well as elements both for guiding said apparatus along the reference edge of the material while cutting the same and for the universal handling of said apparatus regardless of the local and/or geometric position of the material, characterized by the combination of the following features:
a) frame (2) has a cutting head (3) and arms (2.1) in a bifurcated configuration of which the mutual distance at the free ends is variable under tension;
b) the free ends of arms (2.1) have attached thereto cutting tools (3.1) forming the cutting head (3) and acting onto the material planes (5.1) to be cut by virtue of the bias exerted by arms (2.1);
c) cutting tools (3.1) have associated therewith first guide rolls (3.1.1) of which the positions are variable relative to material planes (5.1);
d) one of said arms (2.1) has integrated therewith a guide rail (2.3) on which is mounted a transverse element (4) adjustable and fixable in the longitudinal direction for setting the cutting distance from the reference edge; and
e) transverse element (4) has thereon a guide head (4.1) which straddles the reference edge of the material (5) to be cut, is guided by and along said reference edge and is biased against material (5) to adjust to the thickness thereof, said transverse element (4) also including a handle (4.2) for the manipulation and the direct control of apparatus (1) by the user handling it.

2. The apparatus as in claim 1, wherein bifurcated arms (2.1) comprise a pair of U-shaped planar elements (2.2) held at a mutual distance by connecting elements (2.4) to form a lightweight frame (2).

3. The apparatus as in claim 1 wherein cutting tools (3.1) at the free ends of arms (2.1) comprise cutting wheels (3.1.2).

4. The apparatus as in claim 1, wherein first guide rolls (3.1.1) maintain cutting tools (3.1) in positions suited, on the one hand, to provide an optimum guiding pressure relative to the cutting planes and, on the other hand, to ensure a minimum required resistance for cutting.

5. The apparatus as in claim 1, wherein cutting tools (3.1) secured at the free ends of arms (2.1) form constructionally similar parts each comprising:
a) supporting bodies (3.1.3) at least one of which is adjustable at the free end of an arm (2.1) in vertical position relative to the cutting plane;
b) travelling bodies (3.1.4) secured to supporting body (3.1.3) and mounting first guide rolls (3.1.1) and cutting tools (3.1) positioned between said first guide rolls (3.1.1), with the mutual distance of supporting bodies (3.1.3) being variable at least by the resilient bias of arms (2.1),
c) a distance between first guide rolls (3.1.1) and cutting tool (3.1) (seen in a direction perpendicular to the plane of material (5)) which ensures a positive guiding pressure and the least required resistance for obtaining a proper cutting pressure.

6. The apparatus as in claim 1, wherein guide rail (2.3) has a scale or graduation (2.3.1) thereon.

7. The apparatus as in claim 1, wherein guide head (4.1) has guide elements (4.1.1) with second and third guide rolls (4.1.2, 4.1.3), said guide elements corresponding to the reference edge and being adjustable towards each other and disposed on both cutting planes.

8. The apparatus as in claim 1, wherein handle (4.2) being provided on one of guide elements (4.1.1) to embrace one of arms (2.1).

9. The apparatus as in claim 1, wherein said first, second and third guide rolls (3.11, 4.1.2, 4.1.3) having wear-resistant and/or friction-reducing coatings at least on their races.

10. The apparatus as claim 1, wherein
a) at least one of the constructional groupings and/or one of the component parts referred to hereinabove being designed to be replaceable and
b) at least frame (2) being variable in constructional size by comprising sections not designated and shown.

11. The apparatus as in claim 7, wherein the distance between guide elements (4.1.1) of guide head (4.1) being variable articulatedly against a force exerted by at least one spring element (not shown).

12. The apparatus as in claim 7, wherein at least one guide element (4.1.1) being provided for movement on guide rail (2.3) as a component part of transverse element (4.1), said guide element also having the aforesaid handle (4.2).

13. The apparatus as in claim 1, wherein for setting the cutting distance from the reference edge of material (5) to be cut, transverse element 4, which is mounted on guide rail (2.3) in a manner to be adjustable and fixed in place,
a) is adapted to be fixed in position at a reference point by means not illustrated,
b) with cutting tools (3.1) adapted to perform arcuate cuts on material (5) by correspondingly manipulating and moving apparatus (1),

14. The apparatus as in claim 1, wherein
a) transverse element (4) and the reference edge of material ( ) having therebetween guide-block-like inserts (not illustrated herein) of any curved shape and
b) apparatus (1) being manipulated and guided to cause cutting tools (3.1) to perform curved cuts on material (3) as guided by said blocks.

15. The apparatus as in claim 1, wherein frame (2) has a cross-sectional shape tapering from its closed end to its front end forming the free ends of arms (2.1) accepting cutting head (3), with the rear end of frame (2) being configured to form a second handle (not illustrated) for left- or right-handed manipulation.
